(19) United States
(12) Patent Application Publication
(10) Pub. No.: US 2008/0232146 A1
(43) Pub. Date: Sep. 25, 2008

(54) Efficient Power Supplies and Methods for Creating Such

(75) Inventors: Ted Thomas, Bedford, NH (US); Roman Korsunsky, Downington, PA (US); Michael G. Amaro, Naperville, IL (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/018,645

(22) Filed: Jan. 23, 2008

Related U.S. Application Data
(60) Provisional application No. 60/896,774, filed on Mar. 23, 2007.

(51) Int. Cl. H02M 7/217

(52) U.S. Cl. 363/127

(57) ABSTRACT

Various embodiments of the present invention provide rectifier controllers, power supplies and methods for operating such. As one example, a rectifier controller circuit is disclosed that includes a transistor, a phase locked loop circuit, a period counter and a combinational logic circuit. One leg of the transistor is electrically coupled to a switch node of a power supply, and is in parallel to a diode of the power supply. The phase locked loop circuit receives a signal representing a voltage at the switch node, and is operable to synchronize to a period of the signal representing the voltage at the switch node. The period counter divides the period of the signal representing the voltage at the switch node into segments. The combinational logic circuit is operable to turn the transistor on an assertion delay period after a first transition of the signal representing the voltage at the switch node, and to turn the transistor off before a second transition of the signal representing the voltage at the switch node based on the period counter.

### CROSS REFERENCE TO RELATED APPLICATION

The present application claims priority to (i.e., is a non-provisional of) U.S. Pat. App. No. 60/896,774 entitled “Efficiency Improvement in Non-Synchronous DC/DC Power Supplies Through Addition of Externally Controlled Synchronous Rectifier”, and filed Mar. 23, 2007 by Thomas et al. The aforementioned application is assigned to an entity common hereto, and the entirety of the aforementioned application is incorporated herein by reference for all purposes.

### BACKGROUND OF THE INVENTION

The present invention is related to power supplies, and in particular to power supply efficiency improvement.

Non-synchronous power supplies are popular in the market for their low cost and component count. FIG. 1 shows an exemplary prior art, non-synchronous power supply 100. Power supply 100 includes a DC/DC non-synchronous controller 110 that provides a control output 192 to a switch 190. Control output 192 controls the duty cycle of switch 190 that is responsible for applying a voltage input 170 to a switch node 195. Thus, for example, where five volts is desired at a voltage output 180 and voltage input 170 is ten volts, the duty cycle of switch 190 will be set at fifty percent. A closed loop fixed frequency control 120 receives an input setting that operates to control the voltage at voltage output 180, and provides a feedback signal 112 to DC/DC non-synchronous controller 110. Feedback signal 112 causes changes in the duty cycle of switch 190 designed to cause the desired voltage output 180.

In operation, voltage input 170 is applied to switch node 195 when switch 190 is closed. This delivers a desired current to a resistive load 160 via an inductor 140. The delivered current is filtered by an output capacitor 150. When switch 190 is opened, inductor 140 attempts to maintain the previously delivered current constant across a resistive load 160. This results in the voltage at switch node 195 dropping below a reference ground. In such a situation, a diode 130 is forward biased and sources current to resistive load 160. As an example, where resistive load 160 is one ohm and the desired output voltage 180 is five volts, the power supply will be expected to deliver a constant five ampere current to resistive load 160. Sourcing five amperes through diode 130 which, for example, exhibits a voltage drop of 0.7 volts, results in a dissipation of three and one half watts, during the period of diode conduction. As efficiency requirements become more stringent, the current power dissipation in non-synchronous supplies may not be acceptable, and designers may be required to develop more costly alternatives to their existing power supplies. This is both costly and time consuming.

Thus, for at least the aforementioned reasons, there exists a need in the art for advanced approaches to utilizing power supplies.

### BRIEF SUMMARY OF THE INVENTION

The present invention is related to power supplies, and in particular to power supply efficiency improvement.

Various embodiments of the present invention provide rectifier controller circuits. Such rectifier controller circuits include a transistor, a phase locked loop circuit, a period counter and a combinational logic circuit. One leg of the transistor is electrically coupled to a switch node of a power supply, and is in parallel to a diode of the power supply. The phase locked loop circuit receives a signal representing a voltage at the switch node, and is operable to synchronize to a period of the signal representing the voltage at the switch node. The period counter divides the period of the signal representing the voltage at the switch node into segments. The combinational logic circuit is operable to turn the transistor on an assertion delay period after a first transition of the signal representing the voltage at the switch node, and to turn the transistor off before a second transition of the signal representing the voltage at the switch node based on the period counter. In some cases, the first transition of the signal representing the voltage at the switch node is a falling edge, and the second transition of the signal representing the voltage at the switch node is a rising edge.

In some instances of the aforementioned embodiments, the phase locked loop circuit, the period counter and the combinational logic circuit are implemented on the same semiconductor die. In other instances, the transistor, the phase locked loop circuit, the period counter and the combinational logic circuit are implemented on the same semiconductor die. In various instances of the aforementioned embodiments, the period counter is set to a known value coincident with the second transition of the signal representing the voltage at the switch node.

In some cases, the combinational logic circuit is further operable to turn the transistor off whenever the phase locked loop circuit indicates a loss of lock. Further, in some cases, the combinational logic circuit is operable to turn the transistor off whenever a system enable is de-asserted. In various instances of the aforementioned embodiments, the power supply is a non-synchronous power supply and in other instances, the power supply is a forward converter.

Other embodiments of the present invention provide methods for improving efficiency in a non-synchronous power supply. Such methods include providing a power supply and a rectifier controller circuit. The power supply includes a voltage input electrically coupled to a switch node via a switch, and a diode that is capable of supplying current to the switch node whenever the switch is open. The rectifier controller circuit includes: a transistor, a phase locked loop circuit, a period counter, and a combinational logic circuit. The method further includes electrically coupling the transistor in parallel to the diode with one leg of the transistor being electrically coupled to the switch node, and electrically coupling the phase lock loop circuit to the switch node. The phase lock loop circuit is operable to synchronize to a period of the signal representing the voltage at the switch node, and the period counter divides the period of the signal representing the voltage at the switch node into segments. The combinational logic circuit is operable to turn the transistor on an assertion delay period after a first transition of the signal representing the voltage at the switch node, and to turn the transistor off before a second transition of the signal representing the voltage at the switch node based on the period counter.

In some instances of the aforementioned embodiments, the method further comprises setting the period counter to a known value coincident with the second transition of the signal representing the voltage at the switch node. In some cases, the combinational logic circuit is further operable to turn the transistor off whenever the phase locked loop circuit indicates a loss of lock or when a system enable is de-asserted.

Yet further embodiments of the present invention provide power supplies that include a voltage input that is electrically coupled to a switch node via a switch, and a diode that is capable of supplying current to the switch node whenever the switch is open. In addition, such power supplies include a transistor, a phase locked loop circuit, a period counter and a combinational logic circuit. The transistor is in parallel to the diode with one leg of the transistor being electrically coupled to the switch node. The phase locked loop circuit receives a signal representing a voltage at the switch node, and is operable to synchronize to a period of the signal representing the voltage at the switch node. The period counter divides the period of the signal representing the voltage at the switch node into segments. The combinational logic circuit is operable to turn the transistor on an assertion delay period after a first transition of the signal representing the voltage at the switch node, and to turn the transistor off before a second transition of the signal representing the voltage at the switch node based on the period counter. In particular instances of the aforementioned embodiments, the switch is controlled by a DC/DC non-synchronouns controller.

This summary provides only a general outline of some embodiments according to the present invention. Many other objects, features, advantages and other embodiments of the present invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several drawings to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 depicts a prior art, non-synchronous power supply;

FIG. 2 shows an efficient power supply in accordance with some embodiments of the present invention;

FIG. 3 is a block diagram for a rectifier controller in accordance with various embodiments of the present invention;

FIG. 4 depicts a signal conditioner that may be used in relation with one or more embodiments of the present invention;

FIGS. 5a-5b are timing diagrams depicting an exemplary operation of an efficient power supply in accordance with some embodiments of the present invention;

FIG. 6 is an efficient forward converter in accordance with other embodiments of the present invention; and

FIG. 7 is a flow diagram depicting a method in accordance with different embodiments of the present invention for improving power supply efficiency.

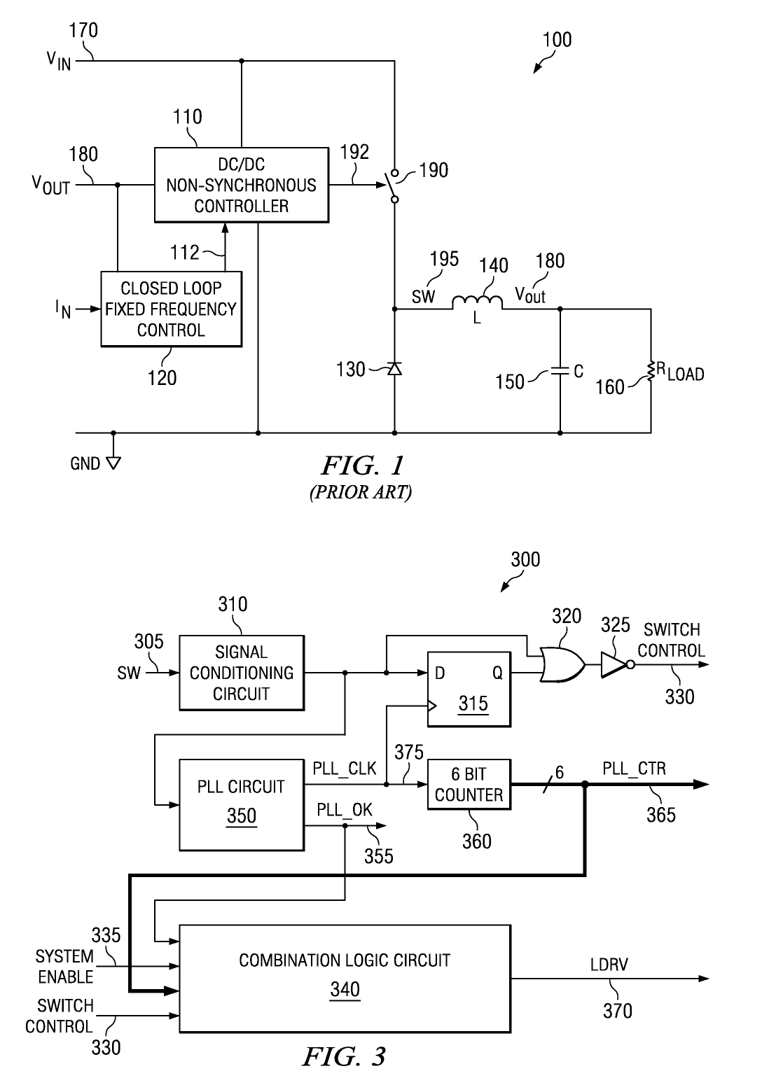

### DETAILED DESCRIPTION OF THE INVENTION

The present invention is related to power supplies, and in particular to power supply efficiency improvement.

Various embodiments of the present invention provide a method for improving power supply efficiency in DC/DC non-synchronous power supplies. Such an improvement is achieved by a changing the power supply from non-synchronous mode of operation to a fully synchronous mode of operation. This may be done through adding a rectifier controller integrated circuit and a transistor to an existing DC/DC non-synchronous power supply. The combination of the rectifier controller integrated circuit and the transistor may substantially reduce any power dissipated in the diode of the existing power supply. In some cases, implementation may be achieved without changes to the original design closed loop frequency compensation. Other embodiments of the present invention may apply a similar approach for increasing efficiency in other topologies such as, for example, a forward converter. In some cases, the transistor is incorporated in the rectifier controller integrated circuit, while in other cases it is discrete from the rectifier controller integrated circuit.

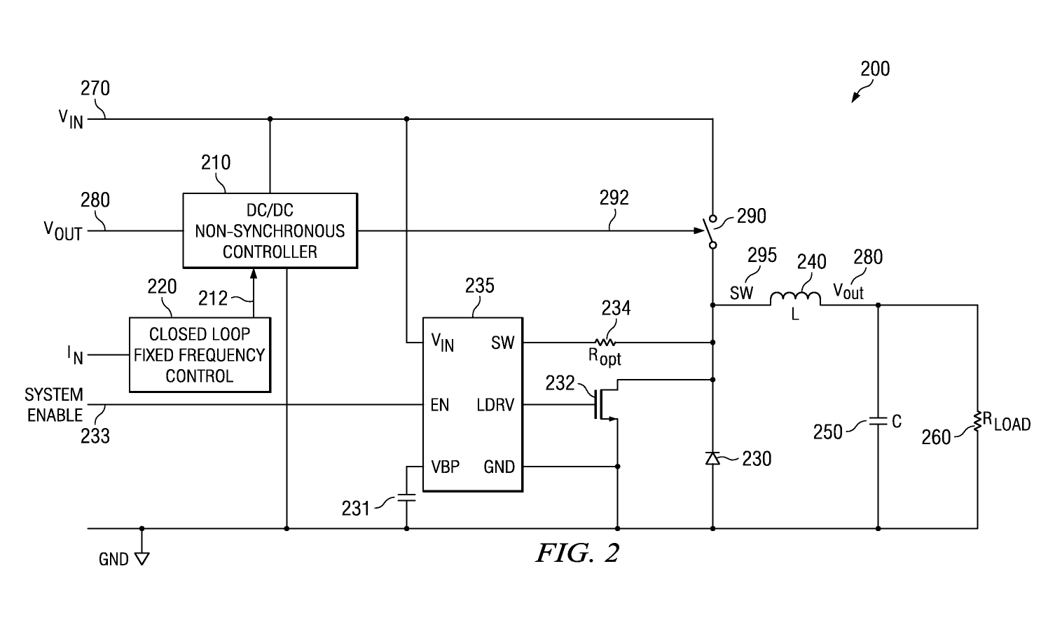

Turning to FIG. 2, an efficient power supply 200 is depicted in accordance with some embodiments of the present invention. Power supply 200 includes a DC/DC non-synchronous controller 210, a closed loop fixed frequency control 220, and a switch 290 as are known in the art. A control output 292 controls the duty cycle of switch 290 that is responsible for applying a voltage input 270 to a switch node 295 as is known in the art. Closed loop fixed frequency control 220 receives an input setting that operates to select the voltage at voltage output 280, and provides a feedback signal 212 to DC/DC non-synchronous controller 210. Feedback signal 212 causes changes in the duty cycle of switch 290 designed to cause the desired voltage output 280. In addition, power supply 200 includes a rectifier controller 235 that controls the switching of a transistor 232. Transistor 232 may be any type of transistor known in the art that is capable of implementing a switch, or may be replaced by some other type of switch element. Rectifier controller 235 is powered from voltage input 270 and ground via a capacitor 231. Further, current controller 235 is electrically coupled to switch node 295 via an optional resistor 234. Optional resistor 234, where included, provides some filtering of the signal available from switch node 295.

In operation, voltage input 270 is applied to switch node 295 when switch 290 is closed. Switch 290 may be implemented using different types of transistors as are known in the art, or by any other comparable switching element. Closing switch 290 causes a desired current to be delivered to a resistive load 260 via an inductor 240. The delivered current is filtered by an output capacitor 250. When switch 290 is opened, inductor 240 attempts to maintain the previously delivered current constant across a resistive load 260. This results in the voltage at switch node 295 dropping below a reference ground. In such a situation, a diode 230 is forward biased and sources current to resistive load 260 for a limited period. When enabled by a system enable input 233, rectifier controller 235 operates to turn on transistor 232 shortly after switch 290 is opened, and to turn off transistor 232 slightly before switch 290 is again closed. Thus, most current that would have been otherwise sourced through diode 230 is sourced through transistor 232. This results in a substantial reduction of power dissipation by power supply 200. Rectifier controller 235 operates to assure that transistor 232 is turned off any time that switch 290 is closed to avoid any damage to either switch 290 or transistor 232.

It should be noted that in some embodiments of the present invention, one or more of resistor 234, transistor 232 and capacitor 230 may be incorporated in a semiconductor device along with the circuitry for rectifier controller 235. Further, in some cases, diode 230 may be incorporated in a semiconductor device along with the circuitry for rectifier controller 235. In yet other cases, diode 230 may be eliminated altogether and a diode inherent in transistor 232 may serve the function of diode 230. Based on the disclosure provided herein, one of ordinary skill in the art will recognize a variety of other modifications that may be made to power supply 200 in accordance with different embodiments of the present invention. In some cases, rectifier controller 235 is implemented such that it is easily incorporated into an existing power supply to effectively convert a non-synchronous DC/DC power supply to a synchronous power supply. As such, it operates to increase the efficiency of a non-synchronous DC/DC power supply.

Turning to FIG. 3, a block diagram of a rectifier controller 300 is shown in accordance with various embodiments of the present invention. Such a rectifier controller may be used in place of rectifier controller 235 of FIG. 2. Rectifier controller 300 includes a signal conditioning circuit 310 that receives an input 305 from a switch node of a non-synchronous power supply, and converts the input signal to a level and quality that may be used internal to rectifier controller 300. The conditioned input is provided to a phase locked loop circuit 350 and a flip-flop 315. Flip-flop 315 is clocked by a clock 375 from phase locked loop circuit 315, and operates to synchronize the output from signal conditioning circuit 310 to clock 375. An OR gate 320 logically ORs the output of signal conditioning circuit 310 with the same signal after synchronization by flip-fop 315. The output of OR gate 320 is inverted by an inverter 325 and provided as a switch control 330. Clock 375 is also provided to a counter 360 that is incremented on a rising edge of clock 375 and is synchronously reset whenever a rising edge of input 305 is detected. In this case, counter 360 is a six bit counter, but it should be noted that other sizes of counters may be used in accordance with different embodiments of the present invention depending upon particular design criteria.

Phase lock loop circuit 350 operates to lock to a frequency having a period measured from successive rising edges of input 305. Once a reasonably consistent frequency is identified, phase locked loop circuit 350 is considered locked and a PLL output 355 is asserted. Otherwise, PLL output 355 is de-asserted. A counter output 365 from counter 360, switch control 330, PLL output 355 and a system enable signal 335 are provided to a combinational logic circuit 340. Combinational logic circuit 340 drives an LDRV output 370 that is electrically coupled to the gate of a transistor in parallel with an existing power supply diode. The function implemented by combinational logic circuit 340 is described by the following pseudo-code:

```
If (System Enable = asserted AND switch control = asserted AND
counter output < MAX)
{
    LDRV = asserted (associated transistor on)
}
Else
{
    LDRV = de-asserted (associated transistor off)
}
```

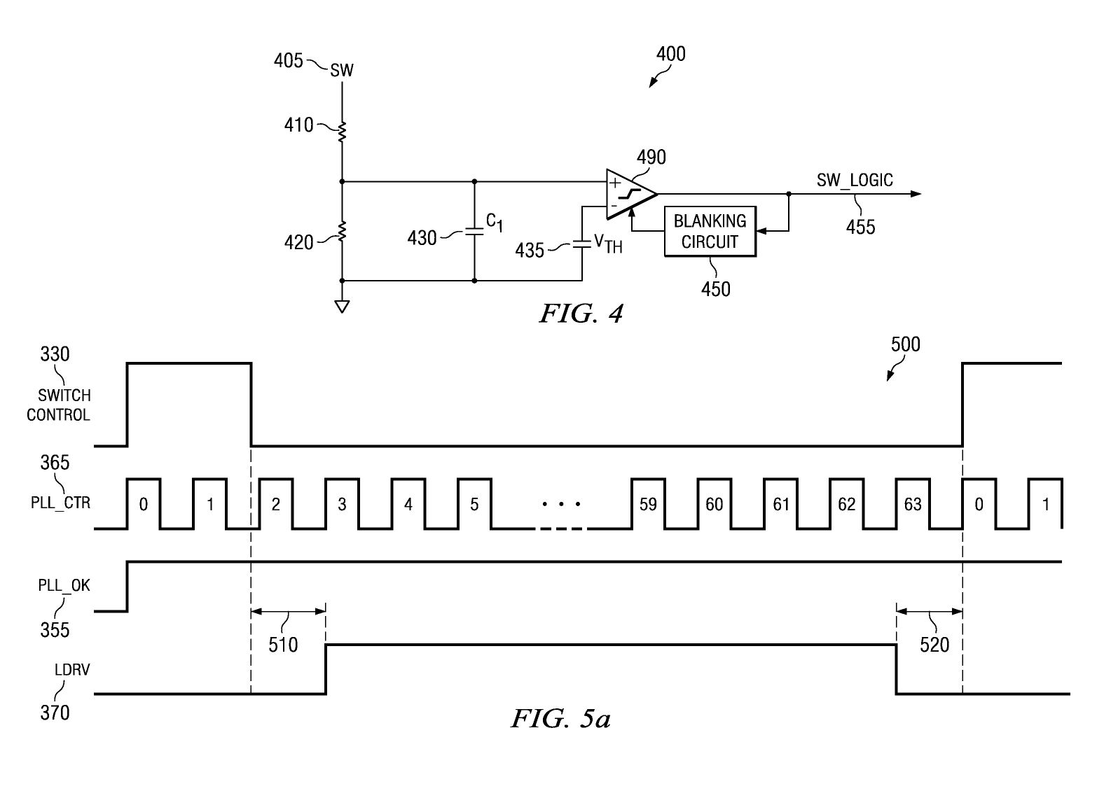

Turning to FIG. 4, a signal conditioner 400 is depicted in accordance with various embodiments of the present invention. Such a signal conditioner may be used in place of signal conditioning circuit 310 of FIG. 3, and provides proper signal scaling and low-pass frequency filtering. Signal conditioner 400 includes a voltage divider implemented using a resistor 410 and a resistor 420. A voltage from a node 415 between resistor 410 and resistor 420 is applied to a comparator 440. The other input of comparator 440 is electrically coupled to a reference voltage 435. A capacitor 440 operates to filter the voltage from the voltage divider. Comparator 440 operates to detect a transition of an input 405, which in this case is electrically coupled to the switch node of a power supply. A blanking circuit 450 limits switching of an output 455 from high to low to ensure that only a single falling edge of output 455 is recorded when switch 290 is opened. In particular, switching from high to low of input 405 is typically accompanied by high frequency ringing due to parasitic elements in the power supply. Parasitic elements are generally always present, and include board trace inductance, lead inductance, and junction capacitances of switching elements and the diode. To avoid any impact of such ringing on output 455, blanking circuit 450 allows for a transition from high to low, but then does not allow a subsequent transition from low to high for a prescribed period sufficient to avoid the ringing.

There are four conditions which are defined for proper operation of rectifier controller 235: (1) an enable operation, (2) control of the edge of the LDRV signal triggered upon assertion of LDRV (in this case a rising edge), (3) control of the edge of the LDRV signal triggered upon de-assertion of LDRV (in this case, a falling edge), and (4) response to fast transient conditions of the main power supply.

For the enable operation, the LDRV output from rectifier controller 235 is de-asserted (i.e., transistor 232 is turned off) whenever system enable 233 is de-asserted. System enable signal 233 may be generated in a number of ways. For example, it may be a logic signal from the power supply indicating readiness. As another example, it may be a resistor divider from the voltage input 270 indicating that the input voltage has reached a predetermined level. As yet another example, it may be a resistor divider from voltage output 280, indicating that the output voltage has reached steady state operation. When the rectifier controller 235 is disabled it would enter a low current standby mode and keep the gate of the synchronous switch in a low state. This mode of operation would take the power supply synchronizing circuitry effectively out of the system.

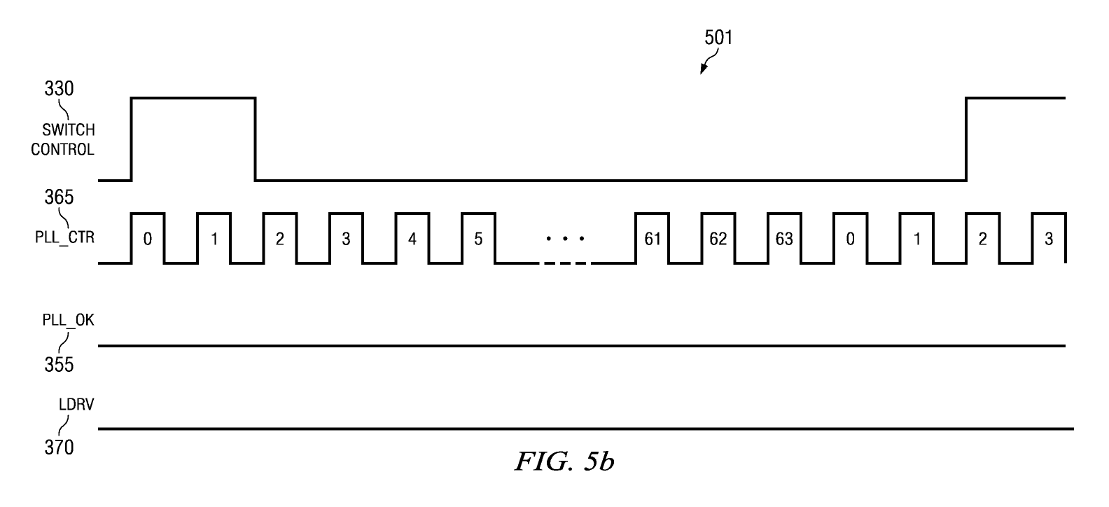

Control of the edges of the LDRV signal is shown in the timing diagrams of FIGS. 5a-5b. Turning to FIG. 5a, a timing diagram shows an exemplary relationship between switch control 330, counter output 365, PLL output 355 and LDRV 370. In this relationship, there is an LDRV assertion delay 510 and an LDRV de-assertion delay 520 designed to avoid an overlap of the closure of switch 290 and the on state of transistor 232. In general, switch 290 is closed whenever switch control 330 is high, and switch 290 is open whenever switch control 330 is low.

Assertion of LDRV 370 is allowed only after assertion delay 510 has passed. As shown assertion delay 510 is a time period from the falling edge of switch control 330 until the second subsequent rising edge of clock 375 as indicated by the change in counter output 365. It should be noted that a greater assertion delay may be used if desired. It should be noted, as shown by a timing diagram 501 of FIG. 5b, LDRV 370 is not asserted unless PLL output 355 (indicating a lock condition) is also asserted. Further, while not shown, system enable 335 must also be asserted for LDRV 370 to assert. As the rising edge of LDRV 370 occurs after the falling edge of switch control 330, assertion delay 510 ensures that switch 290 is not closed at the same time that transistor 232 is turned on.

LDRV 370 is de-asserted prior to assertion of switch control 330. In particular, the period of switch control 330 is identified using phase locked loop circuit 350 such that a subsequent assertion of switch control 330 occurs at approximately a known count of counter 360. One or more cycles of clock 375 before assertion of switch control 330 is expected (as defined by de-assertion delay 520) LDRV 370 is de-asserted. In particular, where phase locked loop circuit 350 sets the rate of counter 360 such that there are 2ⁿ cycles of clock 375 between assertions of switch control 230, then LDRV 370 may be set to de-assert when counter 260 reports a value of 2ⁿ-x. In this case, n is the number of bits of counter 360 and x is the period of de-assertion delay 520 expressed as a number of cycles of clock 375. The granularity of de-assertion delay 520 is limited by the frequency of clock 375 and the number of bits of counter 360. Thus, where it is desired to limit the length of de-assertion delay 520 and yet avoid overlap, the frequency of clock 375 may be increased along with the size of counter 360. Where a longer de-assertion delay 520 is acceptable, de-assertion of LDRV 370 may be effectuated a number of cycles of clock 375 before assertion of switch control 330 is expected, or the frequency of clock 375 may be reduced along with the size of counter 360.

The main power supply could experience a number of functional states with varying transient operating conditions. These states include initial startup, input voltage transient, output load transient, output overload condition, and thermal heating. Each of these conditions are considered to assure proper operation of rectifier controller 235 within the associated power supply. For example, during initial startup, it may be advisable to disable rectifier controller 235 by de-asserting system enable 233. Assertion of system enable 233 may be delayed until steady state operation has been reached by, for example, connecting system enable 233 to a voltage divided version of voltage output 280. In the case of a rapid input voltage transient, the main power supply will only need to modulate the trailing edge of the power switch. If the duty cycle frequency is unaffected, then operation of rectifier controller 235 is not impacted. If, on the other hand, an input voltage transient does cause a disturbance in the frequency of operation, then PLL output 355 will de-assert causing rectifier controller 235 to disable. An output load transient only affects the trailing edge of switch control 330. Since rectifier controller 235 senses switch node 295 directly, an adjustment is made as necessary. Also, a delay of one or more cycles of clock 375 ensures adequate delay in turning on the synchronous switch even in the presence of slight changes at switch node 295. During an overload condition, the main power supply switch will most likely be turned off to prevent a failure of the power supply. This condition will change the operating frequency of the power supply which causes PLL output 355 to de-assert disabling rectifier controller 235. Thermal heating is not a significant concern as the time constant of the power supply is relatively long allowing rectifier controller 235 to adjust its operation to the slow variations in parametric performance of the power supply as it heats and cools.

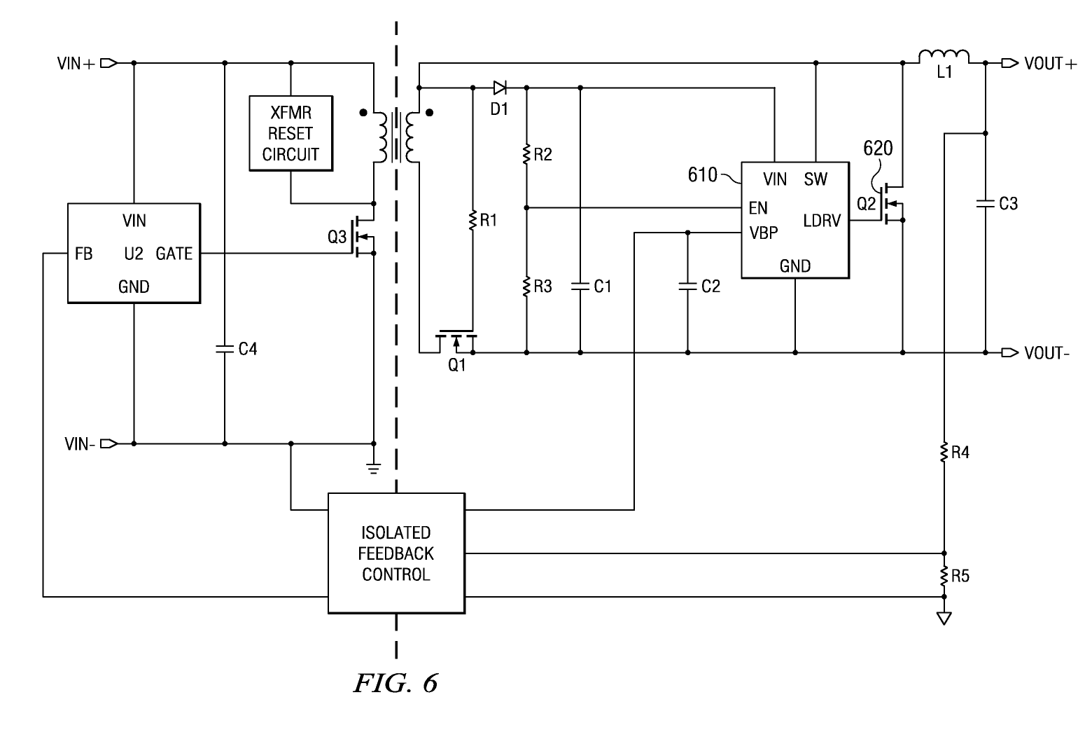

Turning to FIG. 6, an efficient forward converter 600 is depicted in accordance with other embodiments of the present invention. Forward converter 600 is a standard forward converter that is modified by addition of a transistor 620 and a rectifier controller 610 that is similar to that described in relation to FIGS. 2-5 above. Similar to that described above in relation to FIG. 2, addition of transistor 620 and rectifier controller 610 may be used to increase the efficiency of forward converter 600 compared to the efficiency achievable without the modification. Based on the disclosure provided herein, one of ordinary skill in the art will recognize other circuits that can be modified as discussed herein to improve efficiency.

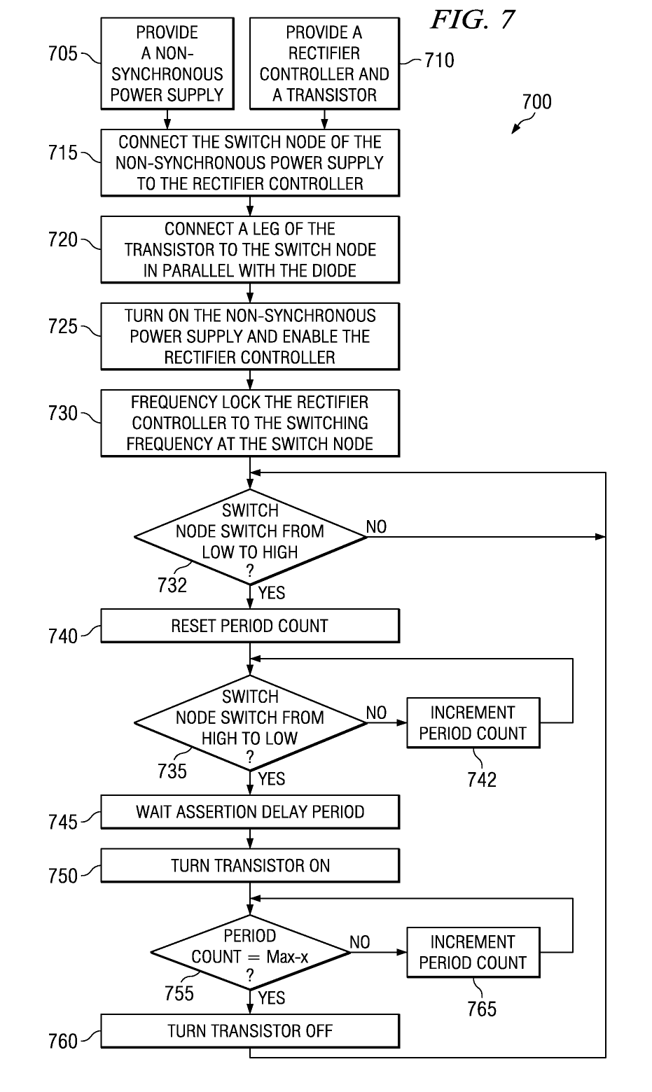

Turning to FIG. 7, a flow diagram 700 depicts a method in accordance with different embodiments of the present invention for improving power supply efficiency. Following flow diagram 700, a non-synchronous power supply is provided (block 705), and a rectifier controller and transistor are provided (block 710). The switch node of the power supply is electrically coupled to the rectifier controller (block 715). As used herein, the phrase “electrically coupled” is used in its broadest sense to mean any coupling whereby an electrical signal may be communicated from one node to another. Such communication may be direct as through a wire, or indirect through an intervening component such as a transistor where an electrical signal is applied to the gate of the transistor and a corresponding signal is received at the source or drain of the transistor. Based on the disclosure provided herein, one of ordinary skill in the art will recognize a myriad of approaches whereby two nodes may be electrically coupled. One leg of the transistor is electrically coupled to the switch node (block 720). The power supply is turned on, and the rectifier controller is enabled (block 725). As previously discussed, during the initial startup of the power supply, the period between rising edges at the switch node may be inconsistent. As such, the phase locked loop of the rectifier controller is unlocked. In this condition, the LDRV output from the rectifier controller is disabled.

Eventually operation of the power supply stabilizes and the phase lock loop circuit in the rectifier controller is able to lock (block 730). The next rising edge of the switch node signal is awaited (block 732). Once the rising edge is detected (block 733), a period counter is reset (block 740). The period counter counts the number of locked clock cycles that transpire between rising edges of the switch node signal. The next falling edge of the signal from the switch node is then awaited (block 735). Where the falling edge is not detected (block 735), the period counter is incremented synchronous to the clock locked by the phase locked loop circuit (block 742). Once the falling edge is detected (block 735), an assertion delay period is awaited (block 745). Once the wait period has expired, the transistor in parallel with the power supply diode is turned on (block 750) to supply current to the switch node effectively taking over for the diode. This take over reduces the power dissipated by an associated power supply. The assertion delay period may be a certain number of cycles of the clock that is synchronized by the phase locked loop circuit of the rectifier controller.

It is then determined if the maximum number of clocks from the preceding rising edge of the switch node have passed (block 755). Where insufficient clocks have passed (block 755), the period counter is incremented synchronous to the clock locked by the phase locked loop circuit (block 765). Alternatively, where the maximum clocks less a number of clock cycles corresponding to the de-assertion delay period (i.e., x) are achieved (block 755), the transistor is turned off (block 760) causing any current needs of the switch node to be sourced again through the diode, and the process returns to awaiting the next low to high transition of the switch node signal (block 732). It should be noted that if lock is lost or the system enable is removed, the transistor is immediately turned off causing current to be sourced through the diode.

Some embodiments of the present invention are implemented with an output voltage independent drive to the synchronous FET. Such an approach limits the possibility of a short circuit from simultaneous turn-on of switch 290 and rectifier 232 compared with other approaches using self-driven control for the synchronous FET. This is especially important given the fact that output voltages are dropping below the level required for FET enhancement. By deriving the bias voltage for the synchronizer by peak detecting the voltage waveform from the transformer, voltages required to achieve proper enhancement or readily obtained. Further, some embodiments may be implemented to provide a regulated bias voltage from this peak detected voltage to source several milliamps worth of bias to implement a cost effective isolated output voltage feedback circuit to the primary. Yet further, some embodiments of the present invention can be implemented to provide a complimentary drive scheme that allows bidirectional current flow through the output filter inductor or a drive scheme that prevents this bidirectional current flow. The later type of control, often referred to by feature name “start-up into pre-bias”, cannot be implemented using simple self-driven techniques but can be easily offered in a highly integrated device that is already sensing the SW node of the transformer and has control over the synchronous FET.

In conclusion, the present invention provides novel systems, devices, methods for efficient power supply implementation and operation. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A rectifier controller circuit, the circuit comprising:
a transistor, wherein one leg of the transistor is electrically coupled to a switch node of a power supply, and wherein the transistor is in parallel to a diode of the power supply;
a phase locked loop circuit, wherein the phase locked loop circuit receives a signal representing a voltage at the switch node, and wherein the phase locked loop circuit is operable to synchronize to a period of the signal representing the voltage at the switch node;
a period counter, wherein the period counter divides the period of the signal representing the voltage at the switch node into segments; and
a combinational logic circuit, wherein the combinational logic circuit is operable to turn the transistor on an assertion delay period after a first transition of the signal representing the voltage at the switch node, and to turn the transistor off before a second transition of the signal representing the voltage at the switch node based on the period counter.

2. The rectifier controller circuit of claim 1, wherein the first transition of the signal representing the voltage at the switch node is a falling edge, and wherein the second transition of the signal representing the voltage at the switch node is a rising edge.

3. The rectifier controller circuit of claim 1, wherein the period counter is set to a known value coincident with the second transition.

4. The rectifier controller of claim 1, wherein the phase locked loop circuit, the period counter and the combinational logic circuit are implemented on the same semiconductor die.

5. The rectifier controller of claim 4, wherein the transistor, the phase locked loop circuit, the period counter and the combinational logic circuit are implemented on the same semiconductor die.

6. The rectifier controller circuit of claim 1, wherein the combinational logic circuit is further operable to turn the transistor off whenever the phase locked loop circuit indicates a loss of lock.

7. The rectifier controller circuit of claim 1, wherein the combinational logic circuit is further operable to turn the transistor off whenever a system enable is de-asserted.

8. The rectifier controller circuit of claim 1, wherein the power supply is a non-synchronous power supply.

9. The rectifier controller circuit of claim 1, wherein the power supply is a forward converter.

10. A method for improving efficiency in a non-synchronous power supply, the method comprising:
providing a power supply, wherein the power supply includes:
a voltage input electrically coupled to a switch node via a switch, wherein the voltage input supplies current to the switch node whenever the switch is closed; and
a diode, wherein the diode is capable of supplying current to the switch node whenever the switch is open;
providing a rectifier controller circuit, wherein the rectifier controller circuit includes:
a transistor;
a phase locked loop circuit;
a period counter, and
a combinational logic circuit; and
electrically coupling the transistor in parallel to the diode, wherein one leg of the transistor is electrically coupled to the switch node;
electrically coupling the phase lock loop circuit to the switch node, wherein the phase lock loop circuit is operable to synchronize to a period of the signal representing the voltage at the switch node, and wherein the period counter divides the period of the signal representing the voltage at the switch node into segments; and
wherein the combinational logic circuit is operable to turn the transistor on an assertion delay period after a first transition of the signal representing the voltage at the switch node, and to turn the transistor off before a second transition of the signal representing the voltage at the switch node based on the period counter.

11. The method of claim 10, wherein the first transition of the signal representing the voltage at the switch node is a falling edge, and wherein the second transition of the signal representing the voltage at the switch node is a rising edge.

12. The method of claim 10, wherein the method further comprises setting the period counter to a known value coincident with the second transition of the signal representing the voltage at the switch node.

13. The method of claim 10, wherein the combinational logic circuit is further operable to turn the transistor off whenever the phase locked loop circuit indicates a loss of lock.

14. The method of claim 10, wherein the method further comprises:
receiving a system enable signal; and
turning the transistor off whenever the system enable is de-asserted.

15. The method of claim 14, wherein the system enable is electrically coupled to a voltage output of the power supply.

16. A power supply, the power supply comprising:
a voltage input, wherein the voltage input is electrically coupled to a switch node via a switch,
a diode, wherein the diode is capable of supplying current to the switch node whenever the switch is open;
a transistor, wherein one leg of the transistor is electrically coupled to the switch node, and wherein the transistor is in parallel to the diode;
a phase locked loop circuit, wherein the phase locked loop circuit receives a signal representing a voltage at the switch node, and wherein the phase locked loop circuit is operable to synchronize to a period of the signal representing the voltage at the switch node;
a period counter, wherein the period counter divides the period of the signal representing the voltage at the switch node into segments; and
a combinational logic circuit, wherein the combinational logic circuit is operable to turn the transistor on an assertion delay period after a first transition of the signal representing the voltage at the switch node, and to turn the transistor off before a second transition of the signal representing the voltage at the switch node based on the period counter.

17. The power supply of claim 16, wherein the first transition of the signal representing the voltage at the switch node is a falling edge, and wherein the second transition of the signal representing the voltage at the switch node is a rising edge.

18. The power supply of claim 16, wherein the period counter is set to a known value coincident with the second transition of the signal representing the voltage at the switch node.

19. The power supply of claim 16, wherein the phase locked loop circuit, the period counter and the combinational logic circuit are implemented on the same integrated circuit, and wherein the integrated circuit is tailored for addition to an existing power supply design.

20. The power supply of claim 16, wherein the switch is controlled by a DC/DC non-synchronouns controller.
